(19) United States
(12) Patent Application Publication
(10) Pub. No.: US 2008/0113647 A1
(43) Pub. Date: May 15, 2008

(54) METHOD AND APPARATUS FOR LOW COST TELEPHONE

(76) Inventors: Robert Czajkowski, Carlsbad, CA (US); Owens F. Alexander, Rancho Santa Fe, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/940,247

(22) Filed: Nov. 14, 2007

Related U.S. Application Data
(60) Provisional application No. 60/865,823, filed on Nov. 14, 2006.

(51) Int. Cl. H04M 11/00; H04M 1/02; H04B 1/40

(52) U.S. Cl. 455/407; 455/558; 455/563; 455/575.1; 455/562.1

(57) ABSTRACT

A wireless telephone includes a chipset that includes a controller and radio frequency electronics. A voice recognition module is ported to the controller. The input key cooperates with the voice recognition module to activate a set of functions of the telephone. The voice recognition module simplifies the operation of the telephone and can decrease the number of components needed for operation interaction. The telephone can have dimensions that are roughly the dimensions of a standard credit card. The telephone is encapsulated into a body that is filled with a material that fills voids in the body.

### RELATED APPLICATIONS

This application claims the benefit of U.S. Provisional Patent Applications Ser. No. 60/865,823, filed Nov. 14, 2006, entitled “Cellular Telephone” which is hereby incorporated herein by reference in its entirety.

### BACKGROUND

1. Field

This invention relates generally to wireless telephones, and more particularly to low cost cellular telephones.

2. Background

Cellular telephone technology has advanced tremendously in recent years, with miniaturization making it possible to condense an increasing number of features into a reasonably sized package. For example, cellular telephones incorporating digital camera technology, MP3 players, games, Internet access and even email have been developed. Such cellular phones feed one type of consumer demand. However, the current technological trajectory of increasing cellular telephone technology has some serious drawbacks. In particular, a growing subset of the populace is increasingly shut out of access to cellular technology: and this at a time when there is a general move away from land lines and toward wireless technology worldwide.

One of the limitations imposed by the drive towards complexity is that telephone service providers often subsidize the telephones that they sell through complex amortization plans backed by long term service contracts. However, such long term service contracts generally are made only with those who have at least moderately good credit. Those whose credit history is poor, or who lack substantial credit history, are often denied access to cellular telephone technology because of their inability to satisfy the cellular telephone service provider that they are sufficiently fiscally responsible to enter into a long term contract. It has been suggested that this growing segment of the population could be serviced using prepaid cellular telephone technology. However, without the ability to amortize telephone costs over long term service contracts, telephone service providers must force telephone customers to bear the costs of cellular telephone sets up front.

Prepaid cellular phones have also been touted for use by minors and others who need to be able to make emergency contact with others, but for whom it is cost prohibitive to acquire a separate telephone account with the associated financial responsibilities that go along with such an account. For example, school children may benefit from having access to prepaid cellular phones that are capable of reaching parents, but which are otherwise limited in their capabilities, either because their access is limited to one or a small number of phone numbers, or because the scope of coverage is limited to a relatively small calling area. In ideal circumstances, such telephones would be small enough to be conveniently carried by young children, but capable of providing sufficient sound quality that children would be able to use them without much difficulty.

Therefore. there is a need for inexpensive cellular telephones that are easy to produce and compact in size.

### SUMMARY

Systems, methods and apparatus for a wireless telephone are described. In one embodiment, a wireless telephone includes a chipset that includes a controller and radio frequency electronics. A voice recognition module is ported to the controller. The wireless telephone also includes a microphone, a speaker, and an input key. The input key cooperates with the voice recognition module to activate a set of functions of the telephone. There is also a display that provides visual information to a user. There is a heat sink onto which the chipset is mounted. In one embodiment, the chipset, microphone, speaker, input key, display, and heat sink are encapsulated into a body having a height of about 83-88 millimeters, a width of about 50-55 millimeters, and a depth, or thickness, of about 4-6 millimeters. In other embodiments, the dimensions of the body can be any desired size.

The wireless telephone can also include a memory module. Also, the input key and the voice recognition module can cooperate to receive a telephone number from a user. The voice recognition module can be configured for a language in accordance with where the telephone is intended to be used. In one embodiment, the voice recognition module comprises software that controls the operation of the control chip.

In one embodiment, the encapsulated body comprises a front and a back surface that are laser welded. In another embodiment, the encapsulated body comprises a front and a back surface and an epoxy that seals the front surface to the back surface. The interior of the encapsulating body can be injected with a filler to thereby fill voids within the body. In one embodiment, the filler is buoyant.

In one embodiment, the telephone communicates with a code division multiple access (CDMA) network. In another embodiment, the telephone communicates with a global system for mobile communications (GSM) network. In still another embodiment, the telephone includes a prepaid account. In one embodiment the telephone will communicate outgoing calls and not receive incoming calls. In one embodiment, the telephone includes a power management module.

In one embodiment a method of making a wireless telephone includes porting a voice recognition module to a controller in a chipset, the chipset comprising the controller and radio frequency electronics. Mounting the chipset onto a heat sink. Installing the chipset and heat sink, a microphone, a speaker, a display, and an input key into a body, wherein the body includes opening for the microphone, speaker, display, and input key, wherein the input key cooperates with the voice recognition module to activate a set of functions of the telephone. Injecting a filler material into an interior of the body, wherein the material fills any voids in the body. In one embodiment, the body has a height of about 83 to 88 millimeters, a width of about 50 to 53 millimeters, and a depth, or thickness, of about 4 to 6 millimeters. In other embodiments, the body can have other desired sizes.

In one embodiment, the body comprises a front and a back surface that are laser welded together. In another embodiment, the body comprises a front and a back surface and an epoxy that seals the front surface to the back surface. In one embodiment, the filler is an epoxy. In one embodiment, the filler is buoyant so that the telephone floats.

In yet another embodiment, a method of controlling a wireless telephone includes porting a voice recognition module to a controller. Providing a simplified user interface for controlling the telephone, the user interface comprising a user input key and a set of voice commands that are used to change the configuration of the telephone. Providing radio frequency electronics that interface with the controller and transmit and receive radio signals with a cellular base station.

In still another embodiment, a wireless telephone includes a chipset comprising a controller and radio frequency electronics. A voice recognition module that is ported to the controller. A microphone and a speaker. An input key that cooperates with the voice recognition module to activate a set of functions of the telephone. A display that provides visual information. A heat sink onto which the chipset is mounted. Wherein the chipset, microphone, speaker, input key, display, and heat sink are encapsulated into a body that is filled with a material that fills voids within the body and makes the body waterproof.

In another embodiment, a method of using a wireless telephone includes providing a user with a wireless telephone. The wireless telephone comprising, a chipset comprising a controller and radio frequency electronics, a voice recognition module that is ported to the controller, a microphone and a speaker, an input key that cooperates with the voice recognition module to activate a set of functions of the telephone, a display that provides visual information, a heat sink onto which the chipset is mounted, and wherein the chipset, microphone, speaker, input key, display, and heat sink are encapsulated into a body that is filled with a material that fills voids within the body. The method also includes establishing a user time account with a starting balance, decreasing a balance of the time account in relation to a number of time units that the wireless telephone is used, and deactivating the telephone when the balance of the time account reaches zero.

Other features and advantages of the present invention should be apparent after reviewing the following detailed description and accompanying drawings which illustrate, by way of example, aspects of the invention.

### BRIEF DESCRIPTION OF THE DRAWINGS

These and other aspects, advantages and details of the present invention, both as to its structure and operation, may be gleaned in part by a study of the accompanying exemplary drawings, in which like reference numerals refer to like parts. The drawings are not necessarily to scale, emphasis instead being placed upon illustrating the principles of the invention.

FIG. 1 is a block diagram of an embodiment of a wireless cellular communication system.

FIG. 2A is a block diagram of a front view of an embodiment of a cellular or wireless telephone that can be used in the cellular communication system of FIG. 1.

FIG. 2B is a block diagram of a side view of the telephone 100 of FIG. 2A.

FIG. 3A is a block diagram of a front view of another embodiment of a cellular or wireless telephone that can be used in the cellular communication system of FIG. 1.

FIG. 3B is a block diagram of a side view of the telephone 100 of FIG. 3A.

FIG. 4 is a block diagram of an example embodiment of a cellular or wireless telephone, such as the telephone of FIGS. 3A and 3B.

FIG. 5 is a flow diagram illustrating aspects of using a prepaid cellular telephone.

FIG. 6 is a flow diagram illustrating aspects of using a prepaid cellular telephone.

FIG. 7 is a flow diagram illustrating aspects of a method of making a wireless telephone.

### DETAILED DESCRIPTION

Certain embodiments as disclosed herein provide for methods and systems for communication over a wireless air interface. After reading this description it will become apparent how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

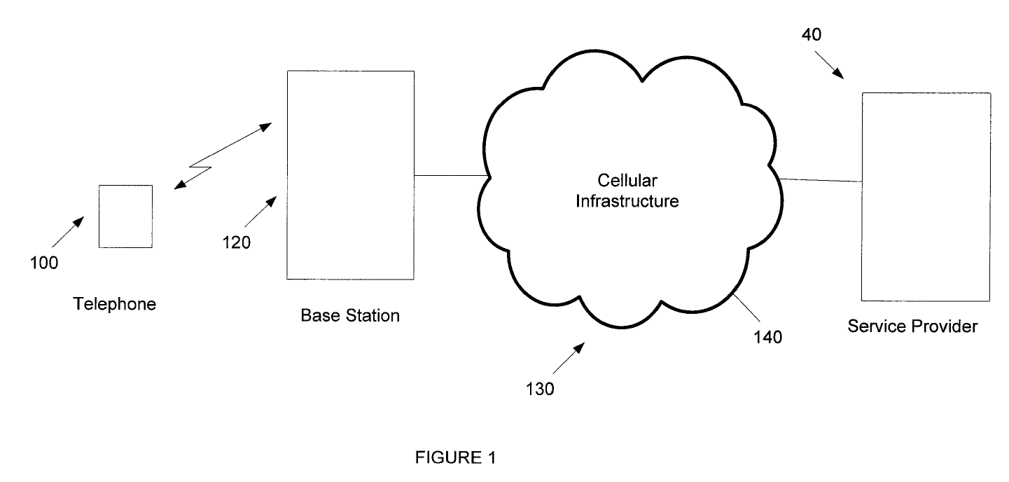

A cellular telephone is provided that is convenient to use, of small dimension, and sufficiently inexpensive to manufacture that it may be considered disposable. FIG. 1 is a block diagram of an embodiment of a wireless cellular communication system. In the example of FIG. 1, a cellular telephone 100, is in communication with a base station 120. In one embodiment, the cellular telephone 100 can be a prepaid cellular telephone.

In one embodiment, data is transmitted between the cellular telephone 100 and the base station 120 to facilitate voice communications. In other embodiments, data transmitted between the cellular telephone 100 and the base station 120 can support other types of communications.

In one embodiment, the communication between the cellular telephone 100 and the base station 120 is based on code division multiple access (CDMA) techniques. In another embodiment, the communication between the cellular telephone 100 and the base station 120 is based on global system for mobile communication (GSM) techniques. In other embodiments, the communication between the cellular telephone 100 and the base station 120 can be based on Worldwide Interoperability for Microwave Access (WiMAX) standards (i.e., the Institute for Electrical and Electronics Engineers (IEEE) 802.16 Standards), Wi-FI (i.e., the Institute for Electrical and Electronics Engineers (IEEE) 802.11 Standards), or other wireless techniques.

The base station 120 is also in communication with a cellular infrastructure 130. The cellular infrastructure 130 can include one or more networks. For example, the cellular infrastructure 130 can include the Public Switched Telephone Network (PSTN), Wide Area Networks (WAN), such as the Internet, and other wired and wireless networks. Also in communication with the cellular infrastructure 130 are other entities. For example, a service provider 140 can be in communication with the cellular infrastructure 130. In one embodiment, the service provider 140 is a prepaid cellular service provider. The prepaid cellular provider can maintain an account for a prepaid cellular telephone 100. For example, the account can maintain a record of a number of time units, or minutes, that a user of the prepaid cellular telephone has purchased and the number of time units that the user has used.

While the embodiment of FIG. 1 shows only one cellular telephone 100 in communication with the base station 120, in other embodiments there can be a plurality of cellular telephones 100 in communication with the base station 120. In addition there can be a plurality of base stations 120. Furthermore, there can be a plurality of other entities in communication with the cellular infrastructure 130.

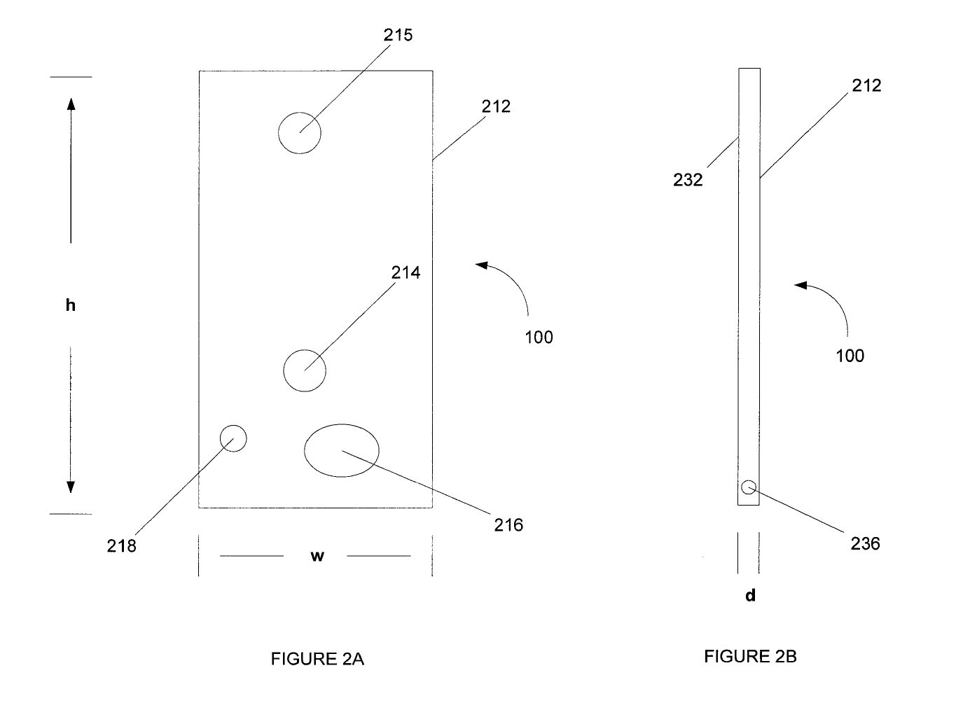

FIG. 2A is a block diagram of a front view of an embodiment of a cellular or wireless telephone that can be used in the cellular communication system of FIG. 1. As shown in the example of FIG. 2A, the telephone 100 includes a body 212, which encloses a control chip and other chips, referred to as a chipset, (not shown) comprising radio frequency electronics, digital electronics, firmware and optionally memory (not shown). The chipset can be adapted to radiate and receive radio frequency signals from and to wireless base stations via an antenna. The chipset can also provide voice recognition and voice activated control of the telephone. In one embodiment, a voice recognition module is ported to the control chip. For example, the voice recognition module may include software, or firmware, or both, that controls operation of the control chip to implement voice recognition functions. In another example, the voice recognition module can include software, or firmware, or both that are installed into a memory module and the control chip access the memory module to implement voice recognition functions. In still another example, the voice recognition module can include hardware that cooperates with the control chip to implement voice recognition functions. In one embodiment, porting the voice recognition module to the control chip comprises interfacing the control module to the control chip. Using voice recognition can simplify the operation of the telephone 100 and help to reduce the size of the telephone 100 by reducing or eliminating a number of keys in a keypad or keyboard of the telephone. In one embodiment, the body 212 has a passage through which a microphone 214 can receive analog voice signal. The voice signal is delivered to the chipset, or digital electronics. The body 212 can also have a passage through which a speaker 215, he speaker 215 can receive analog electric signals and produce sound waves transmit an analog voice signal. In one example, the microphone and speaker operations can be combined.

The body 212 can also include an opening for a power switch 216, which can turn the telephone 100 on and off. In addition, the body 212 has can have an opening for an indicator light 218. In one embodiment, the indicator light 218 can light when the telephone 100 is turned on, blink when the telephone 100 is connected to the network, and to turn off when the telephone 100 is turned off.

The body 212 has a height h and width w, which may be any size. In one embodiment, the height h and width w are selected to correspond to the approximate height and width of a typical credit card. In one embodiment, the height h and width w may be about 83 to 88 millimeters and about 50 to 55 millimeters.

FIG. 2B is a block diagram of a side view of the telephone 100 of FIG. 2A. As shown in FIG. 2B, the telephone 100 has a back 232 and a battery jack 236 in its side. The battery jack 236 can be used to connect an external battery or to charge an internal battery. In one embodiment, the battery is a disposable battery of the ultra thin variety. In one embodiment, the telephone 100 has a depth d, or thickness that may be any value, for example, about the depth of a typical credit card, i.e. about 1 mm. In another embodiment, the telephone 10 has a depth d that is about 4 to 6 millimeters.

In one embodiment, the telephone 100 for FIGS. 2A and 2B can be powered on by toggling the power switch 216. The indicator light 218 turns on to indicate that the telephone is activated. The telephone then searches for an available base station, such as an available GSM or CDMA base station. Once a connection to a base station is achieved, the telephone 100 and GSM or CDMA network, or infrastructure, verify the identity of the telephone 100 and establish an account balance belonging to the telephone. In one embodiment, the account balance may be carried in an account on a network server or service provider, in a database in the telephone's onboard memory (e.g. flash memory), or both. In the latter case, the network and the telephone balances can be used as a sort of identification check to verify that the telephone 100 indeed corresponds to the accessed account.

Once the telephone's 100 identity has been verified, and it has been verified that a positive balance remains in the account, the telephone 100 is ready for placing a call. If there is insufficient balance left in the account, the service provider may take one of several steps. First, it may automatically connect the caller to an operator who can take the caller's credit card information to replenish the caller's account; or it may send a power off signal to the telephone, causing it to turn off.

In any case, presuming that there is an adequate balance in the account, the caller speaks into the microphone 214. The voice signal is converted to a digital signal, which is detected by a voice recognition module inside the telephone body 212. If the voice matches a stored telephone number, the telephone sends this number to the base station, which communicates this number to the network and completes the call. Once the telephone call is established, the indicator light 218 begins to blink. Upon completion of the phone call, the telephone caller depresses the power switch 216 briefly, thereby ending the call. If the user decides to shut off the telephone phone 100 e.g. to save battery life, the user depresses the power switch 216 for a longer period of time, such as for at least five seconds. The telephone 100 then breaks its connection with the base station, and turns off. This is indicated by the indicator light 218 turning off.

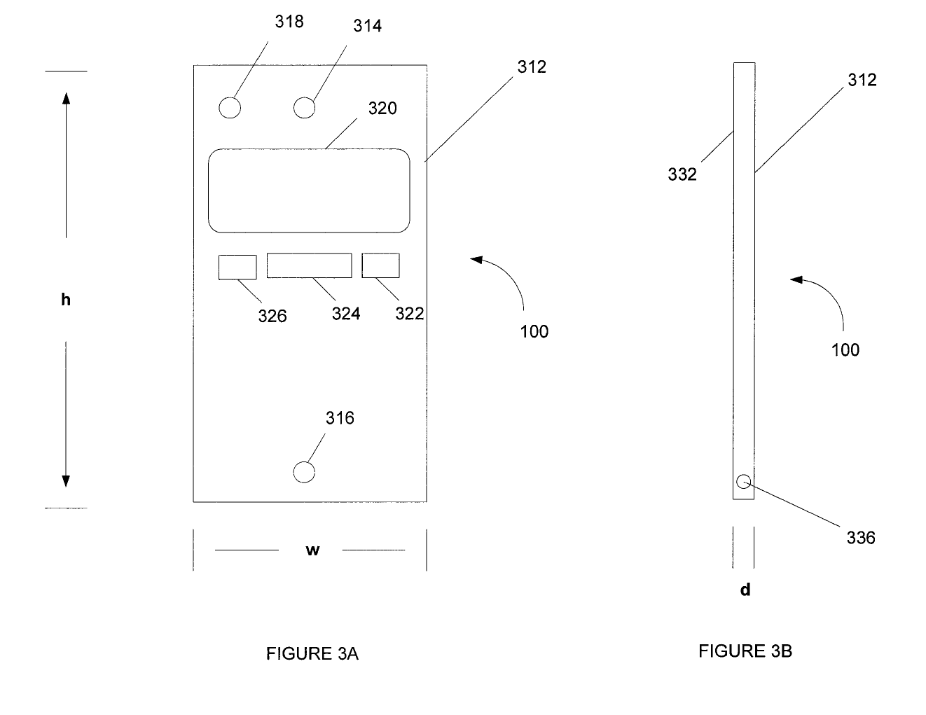

FIG. 3A is a block diagram of a front view of another embodiment of a cellular or wireless telephone that can be used in the cellular communication system of FIG. 1. As shown in the example of FIG. 3A, the telephone 100 includes a body 312, which encloses a chipset (not shown) that can be adapted to radiate and receive RF signals from and to wireless base stations via an antenna. The chipset can also provide voice recognition and voice activated control of the telephone. In one embodiment, a voice recognition module is ported to a control chip. For example, the voice recognition module may include software, or firmware, or both, that controls operation of the control chip to implement voice recognition functions. In another example, the voice recognition module can include software, or firmware, or both that are installed into a memory module and the control chip access the memory module to implement voice recognition functions. In still another example, the voice recognition module can include hardware that cooperates with the control chip to implement voice recognition functions. Using voice recognition can simplify the operation of the telephone 100 and help to reduce the size of the telephone 100 by reducing or eliminating a number of keys in a keypad or keyboard of the telephone.

In the example illustrated in FIG. 3A, the telephone body 312 includes a speaker 314, a microphone 316, an indicator light, or LED, 318, a display 320 and three input devices, such as buttons or keys, 322, 324, and 326. In one embodiment, the three keys are softkeys. In addition, the keys can be watertight. One key 322 can be a power button used to turn the phone on and off. A second key 324 can be used to initiate a call, answer a call or terminate a call. The third key 324 can be used to change a mode of operation of the telephone. For example, the telephone can change for a ring mode to a vibrate mode when an incoming call is received.

The body 312 has a height h and width w, which may be any size. In one embodiment, the height h and width w are selected to correspond to the approximate height and width of a typical credit card. In one embodiment, the height h and width w may be about 83 to 88 millimeters and about 50 to 55 millimeters.

FIG. 3B is a block diagram of a side view of the telephone 100 of FIG. 3A. As shown in FIG. 3B, the telephone 100 has a back 332 and a battery jack 336 in its side. The battery jack 336 can be used to connect an external battery or to charge an internal battery. In one embodiment, the battery is a disposable battery of the ultra thin variety. In another embodiment, the battery is embedded and non-removable. In one embodiment, the telephone 100 has a depth d that may be any value, for example, about the depth of a typical credit card, i.e. about 1 mm. In another embodiment, the telephone 100 has a depth d that is about 4 to 6 millimeters.

In one embodiment, the display 320 can provide information and status of the telephone 100 to a user. For example, the display can provide an indication of the strength of a received signal such as indicated by ascending bars. The display can also provide an indication of a status of the battery, such as indicated by bars in a battery icon. An incoming call notification mode, as described further below, can be indicated by an icon. Likewise, when a voice mail is received it can be indicated by the presence of an icon. When the telephone is in an auto answer mode, as described further below, it can be indicated by the words AUTO ANSWER, or other type of indication. In addition, a called or calling number can be displayed.

In the example of FIGS. 3A and 3B, there are three watertight softkeys 322, 324, and 326. One of the keys 326 is a mode key that allows selection of keywords, as described further below. A second key 324 is a call/answer key that can be used to initiate and outgoing call, answer an incoming call, and terminate a current call or a non-answer call. The third key 322 is a power key and turns the telephone on and off.

The indicator light 318 can be a light emitting diode (LED). In one embodiment, the LED will show one color, such as red, when the telephone is turned on for the first time. After activation the LED will turn to a different color, such as green. The LED will show green for approximately 5 seconds after the phone is subsequently turned on. The LED can also flash a color, such as red, indicating an incoming call. If the telephone is set to silent mode, the flashing LED may be the only indication of the incoming call.

In one embodiment, the functions of the telephone can be limited to only supporting voice communications. Limiting the types of operations that the telephone can support simplifies the components required and can decrease the number, and size, of the components of the telephone. Limiting the size of the components supports reducing the overall size of the telephone. In one embodiment, the size of the telephone 10 can be selected to be approximately the size of a credit card or phone card. By encapsulating the components of the telephone, the telephone is ruggedized and able to withstand some level of abuse and tough handlings. For example, the telephone can be sized to be about the size of a credit card and a user can carry the telephone in their wallet or pocket.

In one embodiment, components that make up the telephone are mounted to a metal plate, such as a steel plate. The metal plate can operate as a heat sink for the components. In one embodiment, the components and the metal plate are encapsulated in a homogenous body. In one embodiment, the body includes a front and a back surface that are laser welded together. In another embodiment, epoxy can be used to bond the front and back surface together. The body can injected with a filler material or gel to fill any voids the in the body. In one embodiment, the body is filled with a buoyant material so that the telephone will float. The encapsulated body can provide mechanical support to prevent, or minimize, component motion due to shock or vibration. The mechanical properties of the encapsulation can improve the survivability of the telephone. In another embodiment, the encapsulation can be made of a buoyant material so that the telephone will float. In addition, the encapsulation can provide a watertight barrier to prevent water from entering the telephone and thereby be waterproof.

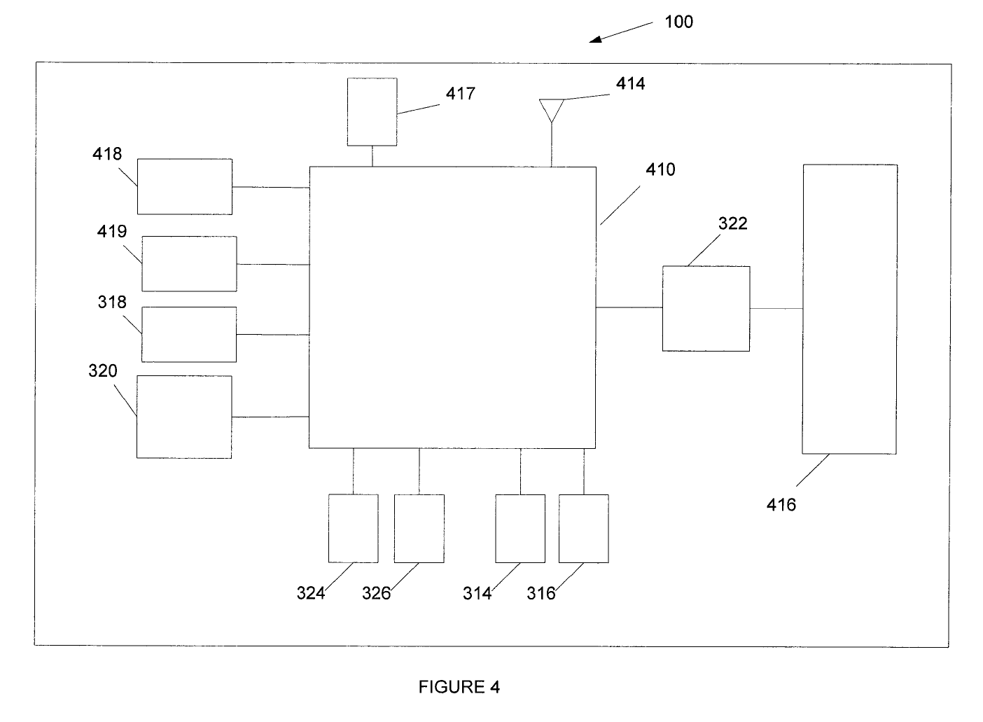

FIG. 4 is a block diagram of an example embodiment of a cellular or wireless telephone 100, such as the telephone of FIGS. 3A and 3B. As shown in FIG. 4, the telephone 100 includes a control chip and other chips, referred to as a chipset, 410. The chip set can be a single electronic integrated circuit (IC) or multiple ICs that cooperate to perform electronic functions of the telephone 100. For example, the chipset 410 can include circuits that control operation of the phone, provide RF transmit and receive operations, interface with a user, and other functions. The chipset 410 can interface and cooperate with a microphone 316 and a speaker 314, which can be separate components or combined into a single unit. The chipset 410 can also include a voice recognition module so that the telephone can be voice activated. In one embodiment, a voice recognition module is ported to a control chip. For example, the voice recognition module may include software, or firmware, or both, that controls operation of the control chip to implement voice recognition functions. In another example, the voice recognition module can include software, or firmware, or both that are installed into a memory module and the control chip access the memory module to implement voice recognition functions. In still another example, the voice recognition module can include hardware that cooperates with the control chip to implement voice recognition functions. Using voice recognition can simplify the operation of the telephone 100 and help to reduce the size of the telephone 100 by reducing or eliminating a number of keys in a keypad or keyboard of the telephone.

For example, the voice recognition module can be ported to the control chip and used to control operation of the telephone 100. For example, the voice recognition module can be used to select a telephone number from a set of predetermined telephone numbers. In one embodiment, a predetermined telephone number can be associated with, for example, a reference number of word, a persons name, such as Bob or Tom, or a location such as home or office, or other word that a user associates with the predetermined number. In another embodiment, the user can dial a telephone number by speaking the numbers into the speaker.

The chipset 410 can also interface to a display 320. For example, the display 320 can provide visual information to a user. In one embodiment, the display 320 comprises an alphanumeric display, or a graphical display. The chipset 410 can also interface to a indicator light or LED 318.

The chipset 410 also includes radio frequency (RF) circuitry to transmit and receive radio frequency signals via an antenna 414. In one embodiment, the antenna 414 transmits and receives RF signals to a cellular base station. The telephone 100 also includes a power key, or switch, 322. The power key 322 provides power to the chipset 410 and other components in the telephone 100. In one embodiment, the power key 322 provides power from a battery 416 to the chipset 410 and other components in the telephone 100. In one embodiment, the battery 416 is included in the telephone 100. In another embodiment, the battery 416 is external to the telephone 100 and the power from the battery is provided the power key 322 via a connector in the telephone 100.

In one embodiment, the chipset 410 further includes a power management module. The power management module can include hardware, firmware, software, or a combination of the above and be adapted to extend the life of the battery. For example, the chipset 410 can include recharging electronics adapted to convert at least a portion of a received radio frequency signal to electrical power and to recharge the battery.

The chipset 410 also interfaces to a call/answer key 324 and a mode key 326. As described further below, the call/answer key 324 can be used to initiate and answer calls from the telephone 100. The mode key 326 can be used to activate various operating modes and features of the telephone 100.

In one embodiment, the telephone 100 includes an optional memory module 417. The memory module 417 can include software the can be used to control the operation of the chipset 410. The optional memory module 417 can also be used for storage of data during operation of the telephone 100. In one embodiment, the telephone 100 includes an optional global positioning system (GPS) module 418. In another embodiment, the GPS module is external to the telephone 100 and communicates information to the telephone 100 via a connector in the telephone 100. In one embodiment, the telephone 100 includes a Subscriber Identity Module (SIM) 419 card. In other embodiments, the telephone includes a connector that will accept a SIM card.

In one embodiment, the chipset 410 provides voice activated dialing only. Optionally, the chipset 410 can include memory and the memory includes a rewritable memory module adapted to store at least one telephone number. In another embodiment, the chipset 410 provides one button access for at least one telephone number and provides voice activated dialing for all other outgoing telephone calls. In one embodiment, the chipset 410 provides one button access for at least one number such as 911, a toll free customer service number, a telephone operator, or a user-defined telephone number. In another embodiment, a set of predetermined numbers can be selected by the user using a key. For example the user could press a key, such as the mode key 326 to cycle from one number to the next through the set of predetermined numbers until a desired number is located. The user can then indicate that they want to call the desired number. For example, the user could then press the call/answer key 324.

In one embodiment, the chipset 410 further comprises a voice recognition module. The voice recognition capability can be used to dial a telephone number stored in memory, or the user can speak a sequence of numbers to be dialed. In one embodiment, the chipset 410 includes a voice recognition module with at least one language profile for a country in which the telephone 100 is to be used. The voice recognition module can be adapted to recognize voice instructions for storing, retrieving and dialing telephone numbers.

In one embodiment, the chipset 410 includes a time register that retains a current balance of time units remaining from a set of time units purchased, or obtained, by a user. In another embodiment, a service provider includes the time register that retains a current balance of time units remaining from a set of time units purchased, or obtained, by a user. The balance of time units may be decreased as the telephone is used. In one embodiment, the telephone is deactivated when the balance of time units reaches zero. In one embodiment, the telephone 100 or service provider further comprises a time unit incrementer, which is a device or process, that can receive an instruction to apply an increase in time units to the balance of time units remaining. For example, a user can purchase addition time units from a retail outlet, a kiosk, online, or other type of consumer store or over the wireless network. After the additional time units have been purchased, the incrementer increases the balance of time units in the telephone. Typically time units can be measured in minutes, tenths of a minute or seconds, for which the telephone 100 may be used. In one embodiment, the incrementer can charge an account for the money value of the increase in time units. In one embodiment, the instruction to apply the increase in time units to the balance of time units remaining is received over the wireless communication system, or wireless network.

In one embodiment, the chipset 410 in the telephone 100 provides access to a wireless network for incoming and outgoing phone calls. In another embodiment, the chipset 410 provides access to a wireless communication network for outgoing phone calls only.

Following is a description of examples of using the telephone illustrated in FIGS. 3A, 3B and 4. A user may depress the power key 322 to turn on the telephone 100. The display 320 activates. A check is made to verify that the battery is charged. The user can then depress the call/answer key 324. The LED 318 will display a first color, such as red, indicating that the telephone is turned on for the first time. The telephone 100 will then automatically attempt to connect with a carrier or service provider and initiate an activation procedure. If the telephone is successful in connecting to the carrier or service provider, then the carrier or service provider will respond with the account of initial minutes and the assigned telephone number which will be stored in the telephone 100. The LED will then change to a different color, such as green, indicating that the telephone 100 is activated. The display 320 will display an indication of the signal strength, such as signal strength bars. The assigned telephone number can be shown on the display. The telephone is now ready to send and receive calls.

As noted, the telephone includes a voice recognition module. The voice recognition module cooperates with the chipset 410 to perform various functions. Some of the functions performed by the voice recognition module and the chipset 410 are described below. For simplicity, the following description uses the phrase voice recognition module to include operations that may be performed by the chipset. In one embodiment, the voice recognition module can be trained. For example, a voice recognition training mode can be entered by pressing the mode key 326. Upon entering the training mode the voice recognition module will take a user through a learning routine to identify the characteristics of the user's voice. For example, the training can include having the user speak various words and phrases, such as, numbers 0-9, commands like yes and no, symbols like star and pound (#), and other keywords like auto answer, minutes, recharge, my number, time, voice mail, train, and the like.

In one embodiment, the following steps can be taken to place a call. The user can initiate the process by depressing the power key 322. The LED 318 will show green indicating that the telephone 100 is activated, and the display will activate. A battery status indicator can show the current charge level of the battery, and a signal strength indicator can show a strength of a received signal. The user can then press the call/answer key 324. The voice recognition module in the telephone 100 will respond with “Please say a phone number.” The user can then speak each digit. The voice recognition module will then respond with “Did you say . . . ” and will repeat the phone number. The voice recognition module then responds “If the number is correct say yes if the number is not correct say no.” The user will then respond accordingly. If the user responds with “yes” the call will be placed. If the user responds with “no” the voice recognition module will ask the user to repeat the number they wish to call.

When a call is placed, if the call answers, the user can conduct their conversation. If the party called does not answer, the user can terminate the attempted call by depressing the call answer 324 key. The user can terminate an existing conversation by depressing the call/answer 324 key or depressing the power 322 key to turn the telephone 100 off.

In one embodiment, the following steps can be taken to receive a call. To receive a call, the telephone 100 is turned on. In one embodiment, if the telephone 100 is in an auto answer on mode, then the incoming call will be automatically answered after a predetermined period of time, for example after 5 seconds. Answering the call can be proceeded by an audible tone. In another embodiment, if the telephone 100 is in an auto answer off mode, the incoming call can be indicated by one of the incoming call notification modes that is currently set, such as chirp, vibrate, blinking LED, or other type of notification mode. To answer the call the user can press the call/answer key 324. To terminate a call the user can press the call/answer key 324 or press the power key 322 to turn the telephone 100 off.

In one embodiment, the mode key 326 can be used to set various operating mode of the telephone, as well as setting options and accessing features of the telephone 100. As noted above, the mode key 326 can be used to enter a training mode for the voice recognition module. In one embodiment, the mode key 326 can be used to access voice messages. For example, if a voice message is received an indication, such as a voice mail icon, can be displayed to indicate the presence of the voice mail. When a user sees the voice mail indication, the user can press the mode key 326 and say the keyword “voicemail.” The voice recognition module can respond with “I will play your voice mail message now . . . voice message received on (time and date) . . . ” and then the message is played. After each message that is played the voice recognition module will ask “would you like to delete this message?” The message can be saved, or deleted, in accordance with the user's response.

In another embodiment the mode key 326 can be used to recharge, or add time to, a user's account. For example, a user can press the power key 322 and turn the telephone 100 on. The user can then press the mode key 326 and say the keyword “Recharge.” The voice recognition module can respond with “enter your recharge pin number.” The user can then say their PIN number. The voice recognition module can then respond with “Did you say . . . ” and repeats the number. Then the voice recognition module can respond with “Say yes if the number is correct or no if the number is not correct.” If the user says “no” the user is asked to again enter their PIN number. After the user has successfully entered their PIN number they can add time to their account. For example, the user can have a pre-established account with their service provider such that the service provider will charge the addition time to the user's credit card, or other form of payment. After a period of time, for example, about 5 minutes the user can verify the new account balance by pressing the mode key 316 and saying the keyword “Minutes.” The new balance of time in the user's account can then be displayed on the display 320 or the voice recognition module can tell the user their new account balance.

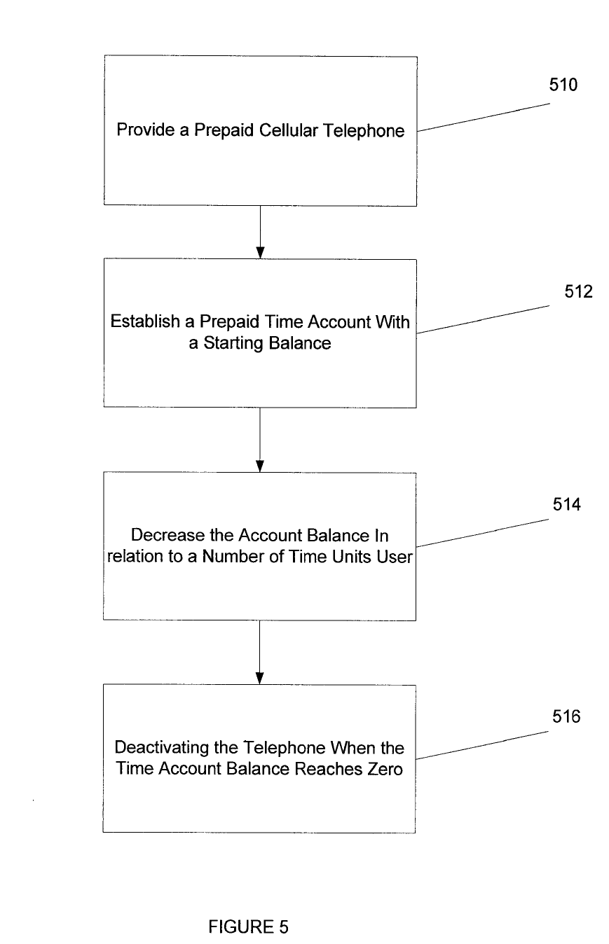

FIG. 5 is a flow diagram illustrating aspects of using a prepaid cellular telephone. Flow begins in block 510 where a user is provided with a prepaid cellular telephone such as the telephone 100 of FIGS. 1-4. For example, the user can purchase the telephone 100 at a retail outlet, or kiosk, online, or other type of consumer store. Flow continues to block 512 where a prepaid time account is established with a starting balance. For example, when a user purchases the telephone 100 the user can purchase a desired number of time units for a starting balance in their time account.

Flow continues to block 514. In block 514 the balance in the user's time account is decreased as the user uses the telephone 100. For example, a service provider entity can monitor the amount of time that the user is connected to the cellular network with the telephone 100 and decrease the balance time account balance accordingly. Flow continues to block 516. In block 516, when the balance in the user's time account reaches zero, the telephone 100 can be deactivated. In another embodiment, when the balance reaches a predetermined threshold, the user can be notified that their account balance is getting low. The user then has the opportunity to replenish their time account balance. For example, the user can purchase additional time units at a retail outlet, a kiosk, online, or over the cellular network, or the like.

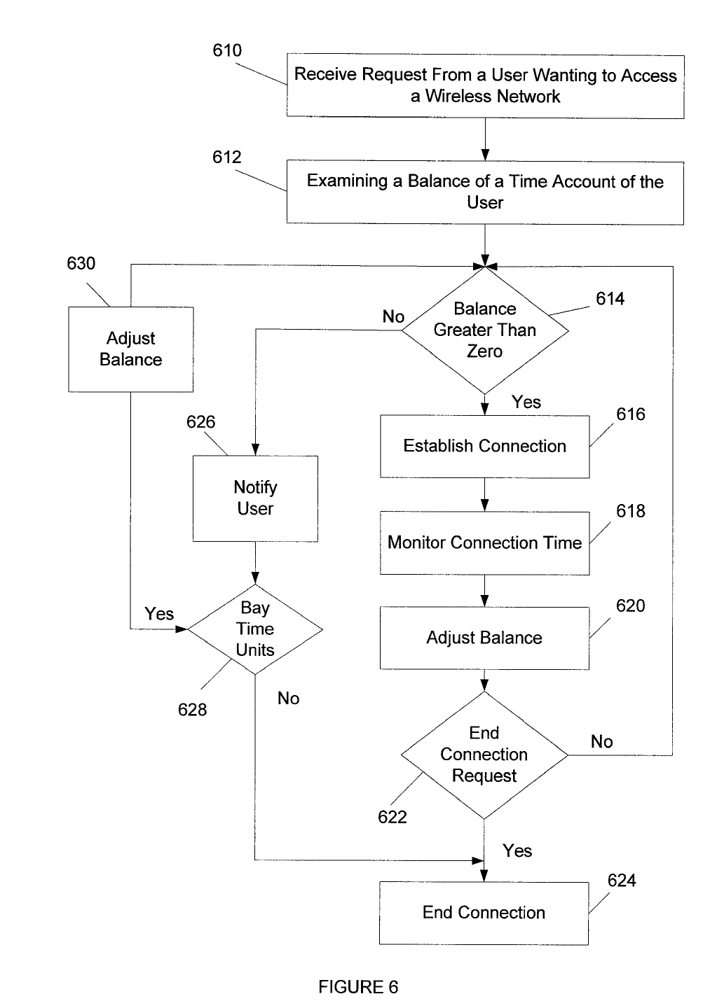

FIG. 6 is a flow diagram illustrating aspects of using a prepaid cellular telephone such as the telephone 100 of FIGS. 1-4. Flow begins in block 610 where a request from a user wanting to access a wireless communication network such as a cellular network is received. Flow continues to block 612. In block 612 a service provider maintains a time account for the user and the service provider examines a balance of the time account of the user. For example, the user may have purchased an amount of network access time and the balance in the time account represents the amount of unused time remaining in the user's account.

Flow continues to block 614 where the service provider determines if the time account balance is greater than zero indicating that the user still has unused time in their account. If the time account balance is greater than zero flow continues to block 616. In block 616 a network connection for the user is established. Flow continues to block 618 where the service provider monitors the connection time. Flow continues to block 620 where the balance of the time account is adjusted according to the connection time. Flow continues to block 622 where it is determined if the user has requested to end the network connection. If the user has requested to end the network connection flow continues to block 624 where the network connection is ended. Returning to block 622, if the user has not requested to end the connection flow continues to block 614 where the balance of the user's time account is checked.

Returning to block 614, if it is determined that the balance of the user's time account is zero flow continues to block 626 and the user is notified. For example, the user can be sent a message indicating that they have used all of the time units in their time account. Flow continues to block 628. In block 628 the user can be given the opportunity to purchase additional time units for their account. If in block 628 the user decides to not purchase additional time units then flow continues to block 624 and the connection is ended. Returning to block 628, if the user purchases additional time units then flow continues to block 630. In block 630 the user's time account is adjusted to reflect the additional time units that were purchased and then flow continues to block 614.

In one embodiment, the user can purchase additional time units from the service provider via the wireless network. For example, the user can have a pre-established account with the service provider, or provide the service provider credit card information, or the service provider may already have the user's credit card information, to purchase the additional time units. In another embodiment, the user is notified when their time account balance reaches a predetermined level. For example, the user can be notified when the balance in their time account reaches a level set by the user, or the service provider, so that the user has the opportunity to purchase additional time units before their account reaches zero. In this way, a user has the opportunity to purchase additional time units, such as from a retail outlet, a kiosk, online, or other type of consumer store before their balance reaches zero.

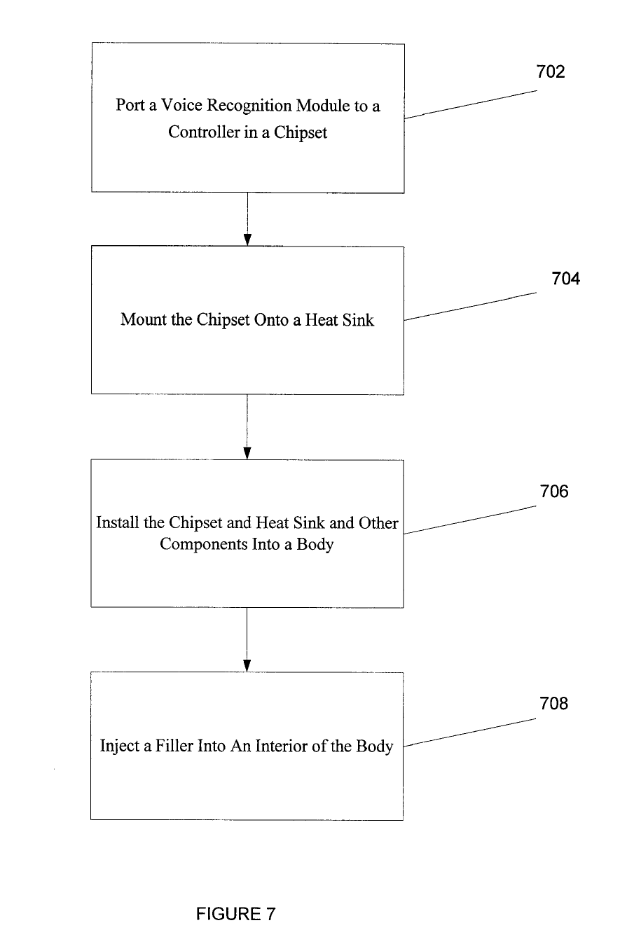

FIG. 7 is a flow diagram illustrating aspects of a method of making a wireless telephone. Flow begins in block 702 where a voice recognition module is ported to a controller in a chipset, the chipset including radio frequency electronics. Flow continues to block 704 and the chipset is mounted to a heat sink. Flow continues to block 706 and the chipset and heat sink, a microphone, a speaker, a display, and an input key are installed into a body. The body includes openings for the microphone, speaker, display, and input key, wherein the input key cooperates with the voice recognition module to activate a set of functions of the telephone. Flow continues to block 708 and a filler material is injected into an the interior of the body such that the filler material fills any voids in the body. In one embodiment, the body has a length of about 50 to 55 millimeters, a width of about 83 to 88 millimeters, and a thickness of about 4 to 6 millimeters.

In one embodiment, the wireless telephone also includes a memory module into the body. Also, the body can include a front and a back surface that are sealed together. For example the front and back surfaces can be laser welded together, or an epoxy can seal the front and back surfaces, or other sealing techniques. The filler material can be an epoxy, or a gel, or other type of material. In addition, the filler material can be buoyant so that the telephone will float.

In one embodiment, a wireless telephone 100 includes a body having a length, width and thickness approximately the same as a standard credit card or phone card, the body enclosing an interior space containing. In another embodiment, the wireless telephone 100 has a body having a length and width of approximately a standard credit card and a thickness of about 4-6 millimeters. The wireless telephone also includes a chipset 410 comprising radio frequency electronics, digital electronics, firmware and optionally memory. The chipset being adapted to radiate and receive digital signals from and to wireless base stations via an antenna 414. The chipset also provides voice recognition and voice activated control of the telephone.

The telephone 100 can also include a microphone 316 adapted to receive analog voice signal and deliver it to the digital electronics. A speaker 314 is included to receive analog electric signals and produce sound waves. There is at least one operating switch. Optionally there is an indicator 318, and a battery adapted to provide power for operation of the telephone 100.

In one embodiment, the battery is located within the body of the telephone 100. In another embodiment, the battery is outside the body of the telephone 100 and the battery is adapted to be reversibly connected to the telephone by a battery connector.

The telephone 100 can be encapsulated so as to prevent user access to the interior space of the body. The encapsulation provides openings for use of the microphone 316, the speaker 314, said at least one operating switch, and when present the indicator, and battery or battery connector. In one embodiment, the antenna is removable, retractable or internal. The encapsulation can further provide an opening for the antenna. In one embodiment, the encapsulation of the telephone 100 is watertight, biodegradable, or both. In one embodiment, the telephone 100 is substantially lead free.

In one embodiment, the digital electronics, firmware, or both, are adapted to provide voice activated dialing only. In another embodiment, the digital electronics, firmware, or both, are adapted to provide one button access for at least one telephone number and to provide voice activated dialing for all other outgoing telephone calls. In one embodiment, the digital electronics, firmware, or both, are adapted to provide one button access for at least one number selected from the group consisting of 911, a toll free customer service number, a telephone operator and a user-defined telephone number. In another embodiment, a set of predetermined numbers can be selected by the user using a button, for example, a user can cycle from one number to the next through the set of predetermined numbers until a desired number is located. The user can then indicate that they want to call the desired number. For example, the user could then hold down the button for an extended period, or the user could press a different button.

The radio frequency electronics, digital electronics and firmware can be adapted to provide access to a wireless network using techniques based on time division multiple access (TDMA), frequency division multiple access (FDMA), global system for mobile communications (GSM), code division multiple access (CDMA), orthogonal frequency division (OFDM), or other wireless techniques. In one embodiment, the radio frequency electronics, digital electronics and firmware can be adapted to access multiple different wireless networks using different wireless techniques.

In one embodiment, the battery is rechargeable, or disposable. In one embodiment, the battery is located within the body of the telephone. In another embodiment, the battery is located outside the body of the telephone.

In one embodiment, the body of the telephone has external dimensions of about 50-100 mm by about 25-75 mm by about 4-6 mm. In other embodiments, the body of the telephone has external dimensions of about 70-90 mm by about 40-60 mm by about 0.75-1.5 mm, or about 75-85 mm by about 45-55 mm by about 0.9-1.2 mm, or about 83 mm by about 50 mm by about 1 mm.

In one embodiment, the encapsulated portion of the telephone has a total mass of about 5 g to about 50 g. In other embodiments, the encapsulated portion of the telephone has a total mass of about 10 g to about 20 g, or 12 to about 18 g, or about 30 to 50 g.

In one embodiment, the body of the telephone 100 includes at least one indicator. The indicator can be used to indicate the on/off status of the telephone, the battery condition, the call status of the phone (i.e. whether a call is connected or not), or other status. In one embodiment, the telephone 100 includes a flat alphanumeric display. The alphanumeric display can be adapted to provide a visual indication of one or more members of the group consisting of caller ID, battery status and remaining minutes status.

In one embodiment, the chipset 410 in the telephone 100 is adapted to provide access to a network for incoming and outgoing phone calls. In another embodiment, the chipset 410 is adapted to provide access to a network for outgoing phone calls only. Optionally, the chipset 410 include memory and the memory includes a rewritable memory module adapted to store at least one telephone number.

In one embodiment, the chipset 410 further comprises voice recognition software, firmware or both. The voice recognition capability can be used to dial a telephone number stored in memory, or the user can speak a sequence of numbers to be dialed. In one embodiment, the chipset 410 includes voice recognition software or firmware set with at least one language profile for a country in which the telephone is to be used. The voice recognition software or firmware can be adapted to recognize voice instructions for storing, retrieving and dialing telephone numbers.

In one embodiment, the chipset 410 further includes power management hardware, firmware or software adapted to extend the life of the battery. For example, the chipset 410 can include recharging electronics adapted to convert at least some received radio frequency signal to electrical power and to recharge the battery.

In one embodiment, the chipset 410 includes a time register adapted to retain a current balance of time units remaining from a set of time units purchased, or obtained, by a user. The balance of time units is decreased as the telephone is used. In one embodiment, the telephone 100 is deactivated when the balance of time units reaches zero. In one embodiment, the telephone 100 further comprises a time unit incrementer, which is a device or process, that is adapted to receive an instruction to apply an increase in time units to the balance of time units remaining. For example, a user can purchase addition time units from a retail outlet, a kiosk, online, or other type of consumer store or over a wireless network. After the additional time units have been purchased, the incrementer increases the balance of time units in the telephone. Typically time units can be measured in minutes, tenths of a minute or seconds, for which the telephone may be used. In one embodiment, the incrementer is further adapted to charge an account for the money value of the increase in time units. In one embodiment, the instruction to apply the increase in time units to the balance of time units remaining is received over the network.

In one embodiment, the chipset 410 further comprises global positioning system (GPS) electronics. The chipset 410 can be adapted to send a caller identification (ID) and GPS location of the telephone 100 to a base station 120. For example, if a user dials 911, the caller ID and GPS position can be sent to the base station 120.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Various illustrative implementations of the present invention have been described. However, one of ordinary skill in the art will see that additional implementations are also possible and within the scope of the present invention.

Accordingly, the present invention is not limited to only those implementations described above. Those of skill in the art will appreciate that the various illustrative modules and method steps described in connection with the above described figures and the implementations disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules and method steps described in connection with the implementations disclosed herein can be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Thus, it is to be understood that the description and drawings presented herein represent example implementations of the invention and are therefore representative of the subject matter which is broadly contemplated by the present invention. It is further understood that the scope of the present invention fully encompasses other implementations and that the scope of the present invention is accordingly limited by nothing other than the appended claims.

1. A wireless telephone comprising:
a chipset comprising a controller and radio frequency electronics;
a voice recognition module that is ported to the controller;
a microphone and a speaker;
an input key that cooperates with the voice recognition module to activate a set of functions of the telephone;
a display that provides visual information;
a heat sink onto which the chipset is mounted; and
wherein the chipset, microphone, speaker, input key, display, and heat sink are encapsulated into a body having a height of about 83-88 millimeters, a width of about 50-55 millimeters, and a depth of about 4-6 millimeters.

2. The telephone of claim 1, further comprising a memory module.

3. The telephone of claim 1, wherein the input key and the voice recognition module cooperate to receive a telephone number from a user.

4. The telephone of claim 1, wherein the voice recognition module is configured for a language in accordance with where the telephone is intended to be used.

5. The telephone of claim 1, wherein the voice recognition module comprises software that controls operation of the control chip.

6. The telephone of claim 1, wherein the encapsulated body comprises a front and a back surface that are laser welded.

7. The telephone of claim 1, wherein the encapsulated body comprises a front and a back surface and an epoxy that seals the front surface to the back surface.

8. The telephone of claim 1, further comprising injecting a filler into the body to thereby fill voids within the body.

9. The telephone of claim 1, wherein the filler is buoyant.

10. The telephone of claim 1, wherein the chipset comprises a power management module.

11. The telephone of claim 1, wherein the telephone communicates with a code division multiple access (CDMA) network.

12. The telephone of claim 1, wherein the telephone communicates with a global system for mobile communications (GSM) network.

13. The telephone of claim 1, further comprising a prepaid account.

14. The telephone of claim 1, wherein the telephone will communicate outgoing calls and not receive incoming calls.

15. A method of making a wireless telephone, the method comprising:
porting a voice recognition module to a controller in a chipset, the chipset comprising the controller and radio frequency electronics;
mounting the chipset onto a heat sink; and
installing the chipset and heat sink, a microphone, a speaker, a display, and an input key into a body, wherein the body includes opening for the microphone, speaker, display, and input key, wherein the input key cooperates with the voice recognition module to activate a set of functions of the telephone;
injecting a filler material into an interior of the body, wherein the material fills any voids in the body, the body having a height of about 83 to 88 millimeters, a width of about 50 to 55 millimeters, and a depth of about 4 to 6 millimeters.

16. The method of claim 15, further comprising installing a memory module into the body.

17. The method of claim 15, wherein the body comprises a front and a back surface that are laser welded together.

18. The method of claim 15, wherein the encapsulated body comprises a front and a back surface and an epoxy that seals the front surface to the back surface.

19. The method of claim 15, wherein the filler is an epoxy.

20. The method of claim 15, wherein the filler is buoyant.

21. The method of claim 15, wherein the radio frequency electronics communicate with a code division multiple access (CDMA) network.

22. The method of claim 15, wherein the radio frequency electronics communicate with a global system for mobile communications (GSM) network.

23. A method of controlling a wireless telephone, the method comprising:
porting a voice recognition module to a controller;
providing a simplified user interface for controlling the telephone, the user interface comprising a user input key and a set of voice commands that are used to change the configuration of the telephone; and
providing radio frequency electronics that interface with the controller and transmit and receive radio signals with a cellular base station.

24. A wireless telephone comprising:
a chipset comprising a controller and radio frequency electronics;
a voice recognition module that is ported to the controller;
a microphone and a speaker;
an input key that cooperates with the voice recognition module to activate a set of functions of the telephone;
a display that provides visual information;
a heat sink onto which the chipset is mounted; and
wherein the chipset, microphone, speaker, input key, display, and heat sink are encapsulated into a body that is filled with a material that fills voids within the body and makes the body waterproof.

25. A method of using a wireless telephone, the method comprising:
providing a user with a wireless telephone, the wireless telephone comprising:
a chipset comprising a controller and radio frequency electronics,
a voice recognition module that is ported to the controller,
a microphone and a speaker,
an input key that cooperates with the voice recognition module to activate a set of functions of the telephone,
a display that provides visual information,
a heat sink onto which the chipset is mounted, and
wherein the chipset, microphone, speaker, input key, display, and heat sink are encapsulated into a body that is filled with a material that fills voids within the body,
establishing a user time account with a starting balance;
decreasing a balance of the time account in relation to a number of time units that the wireless telephone is used; and
deactivating the telephone when the balance of the time account reaches zero.
